(19) United States
(12) Patent Application Publication
(10) Pub. No.: US 2008/0095227 A1
(43) Pub. Date: Apr. 24, 2008

(54) Method And Apparatus Of Sharing Interactive Application

(75) Inventors: Liang Gan, Shanghai (CN); Jingwei Tan, Shanghai (CN); Jun Shi, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,899

(22) PCT Filed: Sep. 29, 2005
(86) PCT No.: PCT/IB05/53209

§ 371 Date: Apr. 9, 2007

(30) Foreign Application Priority Data
Oct. 11, 2004 (CN) 200410085626.3

(51) Int. Cl. H04N 7/12

(52) U.S. Cl. 375/240.01

(57) ABSTRACT

The present invention provides a method for generating a digital program having at least one interactive application, said interactive application is based of at least one data object, said method comprises: first, receiving setting on the sharing characteristic of said data object, then generating a corresponding interactive application according to said setting, finally, associating the generated interactive application with said digital program. The setting of said sharing characteristic includes “sharable” and “non-sharable”. The present invention adds a sharing characteristic parameter to each data object in an interactive application at the transmitting end, so that corresponding processing could be easily performed at the receiving end according to the sharing characteristic of each data object.

### FIELD OF THE INVENTION

The present invention relates to a method and apparatus for generating an interactive digital program stream, in particular to a method and apparatus for generating a digital program having at least one interactive application.

### BACKGROUND OF THE INVENTION

Generally speaking, a digital program could include an audio part, a video part and a data part and is associated to zero to a plurality of interactive applications which are included in the data part. Compared with the interactive application, audio and video are passively played to the user. In DVB (Digital Video Broadcasting) standard, a digital program could include zero or a plurality of video sub-streams, i.e., MPEG PES (Motion Picture Experts Group Packetized Elementary Stream), zero or a plurality of audio sub-streams, zero or a plurality of data sub-streams and service information. An extreme example for digital program is that the digital program includes only the data part, that is, it only includes the interactive application.

DVB MHP (Multiple Home Platform) standard is a popular interactive digital program standard, in which interactive application is encoded in the private sections in the form of modules and is multiplexed in the data part of the transmission stream, and then is transmitted by object carousel of digital storage media command and control (DSMCC). The modules of transmission carousel will be repetitively broadcasted. An interactive application could include a plurality of data objects and these data objects could further have different versions in the process of the broadcasting of digital program.

DSMCC module and the audio/video content are transmitted along the broadcast channel in the same transmission stream. DSMCC object carousel defines how and when the module/document including the application is transmitted in the transmission stream together with the audio/video content. All the documents are of one-way transmission, i.e., from the transmitting end to the receiving means, and there is no connection for returning to the transmitting end for the receiving means to request the desired document, so all the documents are continuously and repetitively transmitted, for example, being transmitted once per 10 seconds. Interactive television terminal, such as MHP terminal, e.g., the set top box (STB), searches for the desired document when re-establishing the application.

In addition, DVB MHP standard defines the application information table (AIT) in the private sections for providing information relevant to the application. Said AIT table is also repetitively broadcasted and the minimum repeating rate of each AIT table is 10 seconds.

The European patent application (filing date: Apr. 29, 2003, inventors: JingWei Tan, Jun Shi, Liang Gan, Declan P. Kelly) with the application number of 03101173.7 has described an apparatus and method for storing a data stream into a storage medium, said data stream includes an audio-visual stream and at least one data object associated with said audio-visual stream, and said data object is the data object of an application. The contents disclosed in said patent application will be added hereto in an embedding manner.

In said European patent application, when storing said data stream, said data object and the audio/video content in the data stream are stored separately. During the storing process, it is checked first if there is already similar data object on said storage medium, if there is similar data object, store said data object until there is only one said similar data object is stored on said storage medium; if there is not similar data object stored on said storage medium, store said data object onto said storage medium.

Said European patent application emphasizes particularly on solving such a problem at the receiving end, i.e., how to avoid repetitive storage of the same/similar data objects when respectively storing data objects that are associated with digital program, and thereby to save space. The checking step thereof is to compare the “organization id” and “application id” of said data object to the “organization id” and “application id” of the data object on the storage medium, if they are the same, said data object is similar to the one on said storage medium.

Said European patent application could further determine if said data object should be stored by comparing the “version number” thereof. However, under some circumstances, since the interactive application versions in different digital programs are not managed by the same version management system, the coordination therebetween, such as the comparability of the “version number”, will be difficult. Therefore, said prior art technical solution has certain defect in handling the similarity with the interactive application in the digital program.

Therefore, a method and apparatus that is improved at the broadcasting end/transmitting end for associating an interactive application with a digital program is needed, which could make the interactive application be more easily shared at the receiving end.

### CONTENTS OF INVENTION

One of the objects of the present invention is to provide an improved method and apparatus for generating a digital program having at least one interactive application, which could make said interactive application be more easily shared at the receiving end.

The present invention provides a method for generating a digital program having at least one interactive application; said interactive application is based on at least one data object. Said method comprises the following steps: first, receiving setting of the sharing characteristic of said data object, then generating a corresponding interactive application according to said setting, finally, associating the generated interactive application with said digital program. The setting of said sharing characteristic includes “sharable” and “non-sharable”.

The present invention adds a sharing characteristic parameter to each data object in an interactive application, so that corresponding processing could be easily performed at the receiving end according to the sharing characteristic parameter of each data object. If said data object is “sharable”, it could be handled by the technical solution as disclosed in the above-mentioned European patent application with the application number of 03101173.7; and if said data object is “non-sharable”, said data object could be directly stored without checking to see if any similar data object has been stored.

The present invention further provides an apparatus for generating a digital program having at least one interactive application, said interactive application is based on at least one data object. Said apparatus comprises: a receiving means for receiving setting of the sharing characteristic of said data object; a generating means for generating a corresponding interactive application according to said setting; and an associating means for associating the generated interactive application with said digital program.

Other objects and attainments together will a fuller understanding of the invention will become apparent and appreciated by referring to the following description and claims taken in conjunction with the accompanying drawings.

### DESCRIPTION OF THE DRAWINGS

By means of the demonstrative embodiments and the attached schematic drawings, the present invention and its relevant advantages will be further illustrated. In the drawings:

FIG. 1 is the system block diagram of the apparatus for generating a digital program having at least one interactive application according to one embodiment of the present invention;

FIG. 2 is the schematic drawing of the representation of a version of an interactive application on a display screen;

FIG. 3 is the schematic drawing of the flow of generating a digital program having at least one interactive application according to one embodiment of the present invention.

The corresponding features in all the figures are denoted by the same numerals.

### DETAILED DESCRIPTION OF THE INVENTION

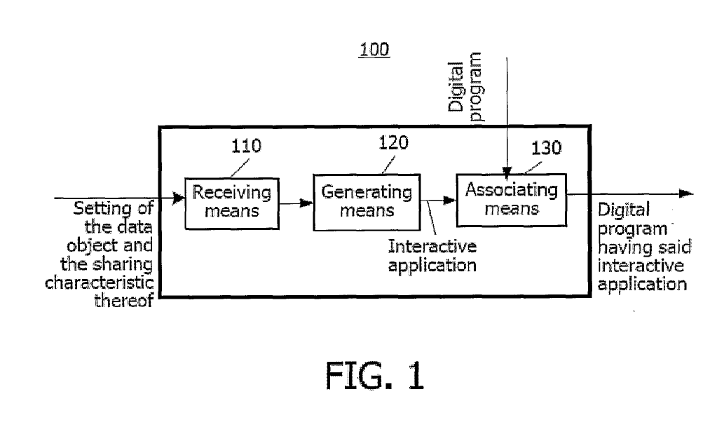

FIG. 1 is the system block diagram of the apparatus for generating a digital program having at least one interactive application according to one embodiment of the present invention. Said interactive application comprises a data object. Means 100 could be a part of the prior art device for making the interactive digital program, such as Coral MHP, and said means 100 comprises a receiving means 110, a generating means 120 and an associating means 130.

The receiving means 110 is used for receiving setting of the sharing characteristic of said data object. Said setting of the sharing characteristic includes “sharable” and “non-sharable”. Said setting could be from the input of the program making person. The receiving means 110 could also be used for receiving said data object.

The generating means 120 is used for generating interactive application having said setting according to the information received by receiving means 110.

The associating means 130 is used for associating the interactive application generated by the generating means 120 with said digital program so as to generate said digital program having said interactive application. Said associating means could be a part of the prior art interactive digital program multiplexer.

The functions of some means in means 100 could be realized by software. For those skilled in the art, said means included in means 100 could be realized by many kinds of prior art means, as long as the combination of said means could achieve the function of the present invention.

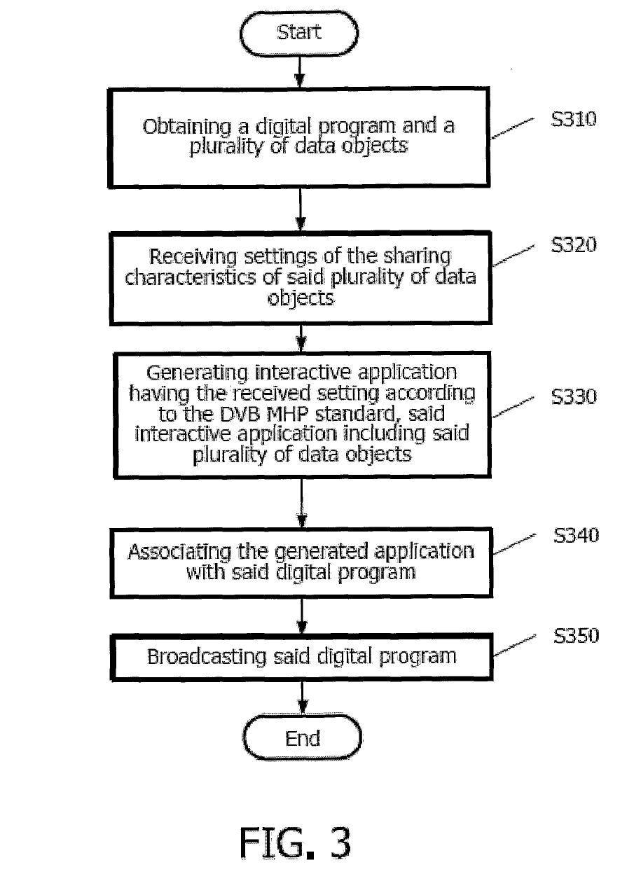

The flow diagram of the operation of means 100 is as shown in FIG. 3.

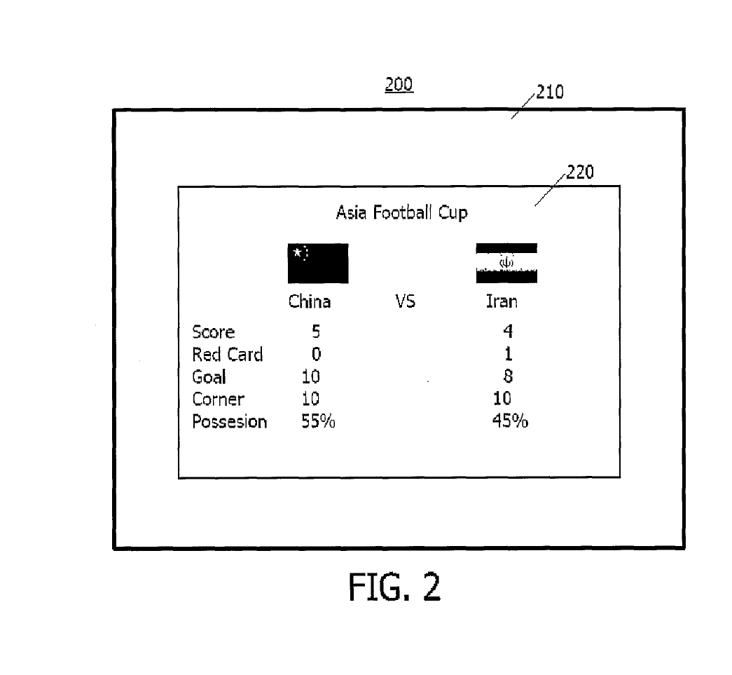

FIG. 2 is the schematic drawing of the representation of a version of an interactive application on a display screen. On the display screen 210, a version 220 of an interactive application is presented. Said interactive application is an application of the game situation of a football game program.

Said score application includes the following files:

1. title.txt, whose content is “Asia Football Cup”;

2. team.txt, whose content is “China VS Iran”;

3. team1.gif, whose content is a national flag of China;

4. team2.gif, whose content is a national flag of Iran;

5. score.txt, whose content is “5 4”;

6. redcard.txt whose content is “0 1”;

7. goal.txt, whose content is “10-8”;

8. corner.txt, whose content is “10 10”;

9. possession.txt, whose content is 55% 45%”.

10. format.class, whose content is the file of the display and editing format of said application, including the positions of the contents of each of the above mentioned files in said application display area, the character strings of “Score”, “Red Card”, “Goal”, “Corner”, “Possession” and their display positions, and the background image of said application, etc.

11. simhei.pfr, which is the font library of said application.

The above-mentioned files are the data objects of said application. During the whole process of said football game program, the contents of score.txt, redcard.txt, goal.txt, corner.txt, possession.txt of said application change with the progress of the game, while the contents of other files remain unchanged. The available principle of sending the data object of an application is to place the unchanged files into the same module while placing the changed files into another module and changing the version number of said module at the same time for the receiving end to identify.

However, in all the football game program on a channel, such as CCTV-5, although the program contents of the games are different, the displaying and editing formats for the applications of game situation could be the same. Therefore, the applications of game situation could use the same templete, for example, game situation applications of different football game programs could use the same format.class and simhei.pfr files. In this way, when the receiving end stores the game situation applications associated with different football game programs, it is no longer necessary to repetitively store said two files.

FIG. 3 is the schematic drawing of the flow of generating a digital program having at least one interactive application according to one embodiment of the present invention. Said digital program could include an audio visual stream and an interactive application associated therewith. Said interactive application includes a plurality of data objects. The interactive application herein does not mean that the execution of said application needs the participation of the user of the digital program, but under some circumstance, said interactive application could operate by itself. For instance, a certain event, such as a goal in a football game, could trigger the interactive application to give an introduction of the footballer that makes the shoot.

First, a digital program and a plurality of data objects are obtained (step S310). Said digital program is the football game program as illustrated in FIG. 2, and said data object is the data object of the interactive application of FIG. 2 including files of title.txt, team.txt, team1.gif, team2.gif, score.txt, redcard.txt, goal.txt, corner.txt, possession.txt, format.class and simhei.pfr.

Second, the setting on the sharing characteristics of said plurality of data objects is received (step S320). According to the need of sharing said application when storing different digital programs at the receiving end, said plurality of data objects are endowed with different sharing characteristics, and said sharing characteristics include “sharable” and “non-sharable”. The contents of the data objects of title.txt, team.txt, team1.gif, team2.gif, score.txt, redcard.txt, goal.txt, corner.txt, possession.txt in the interactive application as shown in FIG. 2 change with the variation of each football game program, so they could be set as “non-sharable”; while the contents of the data objects of format.class and simhei.pfr could remain unchanged in a plurality of football game programs as the game situation application templete, so they could be set as “sharable”.

If a data object is “sharable”, it could be processed by the technical solution as disclosed in the above-mentioned European patent application with the application number of 03101173.7, that is, checking first if said storage medium has stored any similar data object, if it has stored the similar data object, storing said data object until there is only one said similar data object stored on said storage medium; if no similar data object has been stored on said storage medium, then storing said data object on said storage medium.

If said data object is “non-sharable”, storing said data object directly at the receiving end without checking to see if any similar data object has been stored.

Next, interactive application having the received setting is generated according to the DVB MHP standard, and said interactive application includes said plurality of data objects (step S330). The generated application is associated with the digital program (step S340). The data objects of said application are allocated into one or more modules and are finally multiplexed into the private sections.

The sharing characteristic of each data object received in step S320 could be arranged in a transmission module of said application in the form of a file, thus it is ensured that said sharing characteristics and each of the corresponding data object of said application could reach the receiving end at the same time so as to facilitate the receiving means to classify and process them. The advantage of doing so is enabling the prior art DVB MHP receiving end, without any change, to process said sharing characteristics.

The sharing characteristic of each data object received in step S320 could also be arranged in the private data of said digital program in the form of a table. Said table lists the “non-sharable” files in an interactive application, then the rest of the files are “sharable”. The structure of said table is as shown in Table 1.

TABLE 1
table of non-sharable application files

| | | No. of Bits | Identifier |
|---|---|---|---|
| application_information_section( ) | | | |
| { | | | |
| | table_id | 8 | uimsbf |
| | section_syntax_indicator | 1 | bslbf |
| | reserved_future_use | 1 | bslbf |
| | Reserved | 2 | bslbf |
| | section_length | 12 | uimsbf |
| | Service_id | 16 | uimsbf |
| | Reserved | 2 | bslbf |
| | version_number | 5 | uimsbf |
| | current_next_indicator | 1 | bslbf |
| | section_number | 8 | uimsbf |
| | last_section_number | 8 | uimsbf |

| | |
|---|---|
| For (int I=0;I<N; I++){ | N □□section_length |

| | | □ACFD_description_length □□□ |
|---|---|---|
| Organisation_id | 32 | |
| Application_Id | 16 | |
| ACFD_description_length | 16 | |
| for(int j=0;j<M;M++) | | M □□ ACFD_description_length |

□□□

{

| | | |
|---|---|---|
| CarouselId | 32 | uimsbf |
| ModuleID | 16 | |

| | | |
|---|---|---|
| ObjectKey_length | 8 | N |
| For (I=0;I<N;I++){ | | |
| ObjectKey_data_byte | 8 | bslbf |
| } | 12 | uimsbf |

}

| } | | |
|---|---|---|
| CRC_32 | 32 | rpchof |

}

Wherein Table_id could be selected by the broadcaster as long as it could be identified by the receiving means/storage means, for example, 0x 11; CarouselId: is used for identifying the carousel for transmitting said application; ModuleID: is used for identifying the module that contains the corresponding data object; and ObjectKey: is used for identifying a data object.

It shall be noted that the process of generating and associating could be performed according to other current or future digital program making technique.

Finally, said digital program is broadcasted (step S350). It could be broadcasted by satellite or by ground broadcast or cable broadcast.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

1. A method for generating a digital program having at least one interactive application, wherein said interactive application is based on at least one data object, comprising:
receiving setting of the sharing characteristic of said data object,
generating a corresponding interactive application according to said setting, and
associating the generated interactive application with said digital program.

2. The method as claimed in claim 1, wherein the setting of the sharing characteristic of said data object is sharable.

3. The method as claimed in claim 1, wherein the setting of the sharing characteristic of said data object is non-sharable.

4. The method as claimed in claim 1, wherein said data object is arranged in the format of Multimedia Home Platform standard, and said setting includes organization id and application id.

5. The method as claimed in claim 1, further comprising the step of repetitively sending said interactive application during the process of playing of said digital program.

6. The method as claimed in claim 5, wherein said interactive application includes a file which corresponds to said sharing characteristic.

7. The method as claimed in claim 1, wherein said digital program is a digital television program complying with the Digital Video Broadcasting standard, and said associating step comprising multiplexing said sharing characteristic into the private data of said digital program stream in the form of a sharing characteristic table.

8. An apparatus for generating a digital program having at least one interactive application, wherein said interactive application is based on at least one data object, comprising:
a receiving means for receiving setting of the sharing characteristic of said data object,
a generating means for generating a corresponding interactive application according to said setting, and
an associating means for associating the generated interactive application with said digital program.

9. The apparatus as claimed in claim 8, wherein the setting of the sharing characteristic of said data object is sharable.

10. The apparatus as claimed in claim 8, wherein the setting of the sharing characteristic of said data object is non-sharable.
